(19) United States
(12) Patent Application Publication
(10) Pub. No.: US 2004/0085950 A1
(43) Pub. Date: May 6, 2004

(54) Fluorescent multi-layer recording media containing porphyrin and the method for fabricating the same

(76) Inventors: Ming-Chia Lee, Taichung (TW); Wen-Yih Liao, Taichung (TW); Teh Hu, Hsinchu (TW); Chien-Wen Chen, Pingtung (TW); Chung-Chun Lee, Yunlin (TW); Der-Ray Huang, Hsinchu (TW); Tzuan-Ren Jeng, Hsinchu (TW); Chuen-Fuw Yan, Hsinchu (TW)

Correspondence Address: BIRCH STEWART KOLASCH & BIRCH, PO BOX 747, FALLS CHURCH, VA, 22040-0747, US

(21) Appl. No.: 10/372,222

(22) Filed: Feb. 25, 2003

(30) Foreign Application Priority Data
Nov. 1, 2002 (TW) 091132429

(51) Int. Cl. H04L 12/66

(52) U.S. Cl. 370/352

(57) ABSTRACT

The specification discloses a fluorescent multi-layer recording medium containing porphyrin and the method for manufacturing it. The porphyrin is used to make the recording layer of the fluorescent multi-layer recording medium. A laser beam with a wavelength smaller than 500 nm is used as the light source. When a short-wavelength laser excites the recording layer containing porphyrin, it instantaneously emits red fluorescent light with a wavelength greater than 600 nm. A device can read data signals by detecting the intensity of such fluorescence.

### BACKGROUND OF THE INVENTION

1. Field of Invention

The invention relates to a fluorescent multi-layer recording medium and the method for making the same. In particular, the invention pertains to a fluorescent multi-layer recording medium with porphyrin that is suitable in the use of a short-wavelength laser for data access.

2. Related Art

In the information and multimedia dominated world, products including computers, communication devices, and consumer electronics have an increasing demand for a larger storage density in the recording media. Take optical data recording media as an example. For those optical recording media that use the usual red-light laser as the pickup light source, the storage density has an upper limit set by the optical diffraction. Several methods have been proposed to increase the storage density. Some important ones that have recently been implemented include: shortening the wavelength of the pickup laser light (e.g. changing the light source from red lasers to blue lasers, increasing the numerical aperture of lenses); improving the digital signal encoding method; using ultrahigh-resolution near-field optical structures; and producing multi-layer structures in the data recording media to increase the medium capacity. In the last method, the recording media have a three-dimensional structure and the capacity is increased by integer multiples. All these methods can effectively increase the storage density.

In the aspect of shortening the wavelength of the pickup laser light, nine companies including Hitachi, South Korean LG electronics, Hitachi, Pioneer, Philips, Samsung, Sharp, Sony, and Thomson Multimedia have proposed in 2002 a new-generation large-capacity optical disc storage specification, the Blu-ray Disc. A blue-violet laser (with a wavelength of 405 nm) and a 0.1 mm optical protection layer structure are used. The blue-light standard can increase the capacity of a single-sided optical disc to 27 GB. Therefore, it can be seen that using short-wavelength laser beams has gradually become a mainstream.

On the other hand, the conventional three-dimensional multi-layer recording medium technology is restricted by the destructive interference so that the maximal number of layers is limited. In 1989, D. A. Pathenopoulos et al. first proposed to detect the fluorescent radiation intensity of organic color-changing materials under the excitation of laser as the method of reading data signals. This overcame the problem of destructive interference in multi-layer disc structures. Afterwards, Russell further developed a fluorescent multi-layer recording medium and a corresponding pickup optical system, as disclosed in the U.S. Pat. No. 5,278,816. In 2000, Constellation 3D, Inc. demonstrated to the public a prototype player using the fluorescent multi-layer disc (FMD) technology. The FMD uses a fluorescent dye as the multi-layer coating of the disc. When laser light shines on the fluorescent material, fluorescence with a frequency different from that of the laser is radiated from it. The detector inside the optical disc drive detects such fluorescence but ignores the laser beam. Since the fluorescence does not have the problem of destructive interference, many recording layers can be stacked on a single side of the optical disc. It is seen from the above technical development that the recording capacity of the optical recording media can be further increased if one combines the technologies of using short-wavelength laser light and fluorescent multi-layer recording media. Therefore, it is currently an interesting topic to develop a fluorescent dye for short-wavelength lasers.

### SUMMARY OF THE INVENTION

It is an objective of the invention to provide a fluorescent multi-layer recording medium containing porphyrin and the method for making the same. Using porphyrin has the advantage of good quantum efficiency and a great absorption rate for light with a wavelength less than 500 nm. Therefore, it can be used as the dye in a fluorescent multi-layer recording medium. When a short-wavelength laser beam hits the polymer thin film containing porphyrin, the fluorescent radiation instantaneously produced by porphyrin has a wavelength greater than 600 nm. Data signals on the recording medium can be read by detecting the intensity of the fluorescent radiation.

The chemical structure of porphyrin used in the invention is as follows:

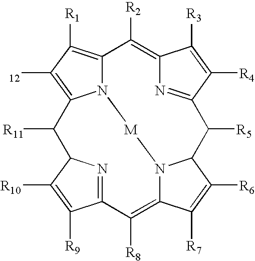

In the chemical structure, R₁, R₂, R₃, R₄, R₅, R₆, R₇, R₈, R₉, R₁₀, R₁₁, and R₁₂ may represent the same or different groups. Such groups are selected from hydrogen atoms, halide atoms, C₁₋₈ alkyl groups containing substitute groups, C₁₋₈ alkyl groups not containing substitute groups, C₁₋₈ alkyl-oxygen groups containing substitute groups, C₁₋₈ alkyl-oxygen groups not containing substitute groups, C₁₋₈ alkyl-ethylene groups, nitro heterocycles, carbonyloxy group, nitro groupadamantyl carbonyl groups, adamantyl groups, alkenyl groups, alkynyl groups, amino groups, azo groups, aryl groups, aryloxy groups, arylcarbonyl groups, aryloxycarbonyl groups, arylcarbonyloxy groups, aryloxycarbonyloxy groups, alkylcarbonyl groups, alkylcarbonyloxy groups, alkoxycarbonyloxy groups, alkoxycarbonyl groups, carbamoyl groups, cyanate groups, cyano groups, formyl groups, formyloxy groups, heterocyclic groups, isothiocyanate groups, isocyano groups, isocyanate groups, nitroso groups, perfluoroalkyl groups, perfluoroalkoxy groups, sulfinyl groups, sulfonyl groups, silyl groups, thiocyanate group. M in the chemical structure is selected from the hydrogen molecule (H₂), Li, Na, Mg, Ca, Sc, Ti, V, Cr, Mo, Mn, Fe, Os, Co, Rh, Ir, Ni, Pd, Pt, Cu, Ag, Au, Zn, Ge, Sn, and Sb.

The fluorescent multi-layer recording medium containing porphyrin and the corresponding manufacturing method disclosed by the invention uses the fluorescent thin film formed from porphyrin as the recording layer. Porphyrin has a large Stoke's shift. The Stoke's shift is the photon (fluorescence) emitted by a fluorescent material during a transition from an excited state to the ground state. Since the energy loss is in the solution or solid state, the fluorescence thus emitted usually has a lower energy (namely, a longer wavelength) than the incident light. The energy difference between the emitted fluorescence and the incident light is called the Stoke's shift. Therefore, for a fluorescent thin-film recording layer with a larger Stoke's shift, the fluorescence can be easily separated from the incident laser beam using a filter. This can avoid the cross-talk between the incident laser beam and the fluorescent radiation. Consequently, the radiation intensity of the fluorescence can be correctly read to extract data signals. Moreover, this can reduce the absorption of fluorescence by the dye itself, reducing the intensity of signals.

As the polymer thin film containing the porphyrin dye has a superior optical and thermal stability, no optical stabilizer is required when a short-wavelength laser beam (less than 500 nm) is used for excitation.

### BRIEF DESCRIPTION OF THE DRAWINGS

The invention will become more fully understood from the detailed description given hereinbelow illustration only, and thus are not limitative of the present invention, and wherein:

FIG. 1 is a fluorescent spectrum of a TPP-OH film on a PC substrate;

FIG. 2 is a picture of the red fluorescent signal spots when the fluorescent optical disc is excited by a 405 nm blue laser;

FIG. 3 is a schematic view of the fluorescent multi-layer recording medium using porphyrin; and

FIG. 4 shows the procedure of the disclosed manufacturing process.

### DETAILED DESCRIPTION OF THE INVENTION

The invention discloses a fluorescent multi-layer recording medium containing porphyrin and the method for making the same. It is suitable for using a short-wavelength (less than 500 nm) laser to access data. The chemical structure of porphyrin is already described hereinbefore. In order to demonstrate the excited radiation properties of porphyrin, we measure the fluorescent efficiency, the maximal absorption position of incident excitation light, and the fluorescent radiation wavelength of the following porphyrin compounds.

(1)5,10,15,20-Tetraphenyl-21H,23H-Porphyrin (hereinafter as TPP) has the following structure:

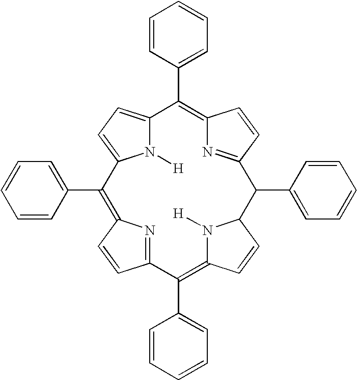

(2)5,10,15,20-Tetrakis(4-hydroxyphenyl)-21H,23H-Porphyrin (hereinafter as TPP-OH) has the following structure:

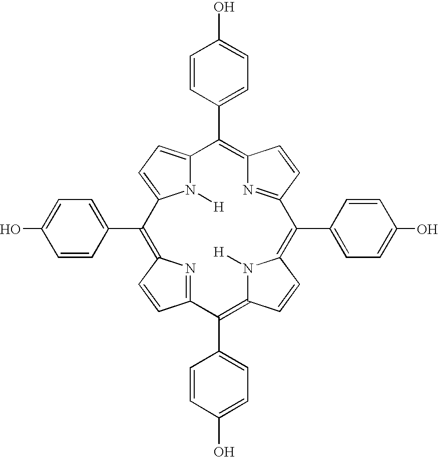

(3)5,10,15,20-Tetrakis(4-carboxyphenyl)-21H,23H-Porphyrin (hereinafter as TPP-COOH) has the following structure:

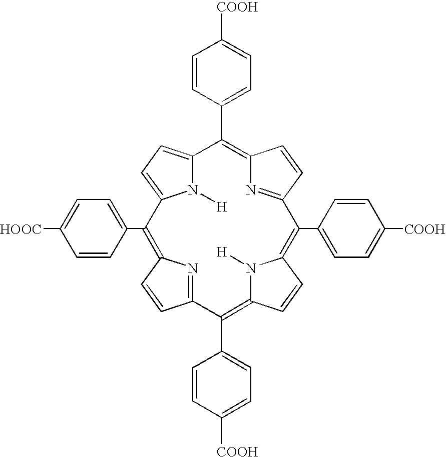

(4)5,10,15,20-Tetrakis(4-adamantyl-carbonyl)-21H,23H-porphyrin (hereinafter as TPP-ADMT) has the following structure:

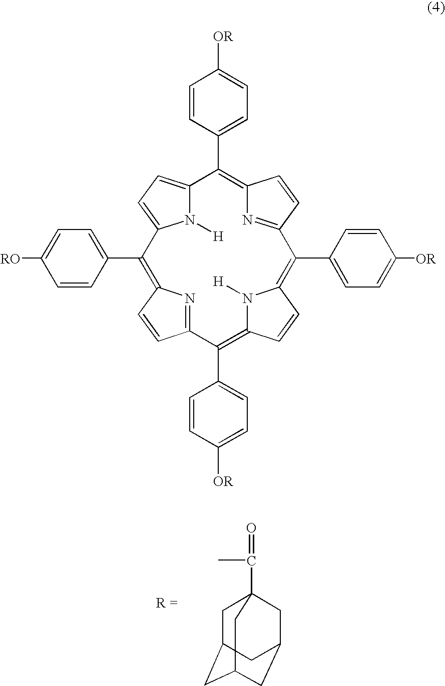

(5)5,10,15,20-Tetraphenyl-21H,23H-porphyrin zinc (hereinafter as Zn-TPP) has the following structure:

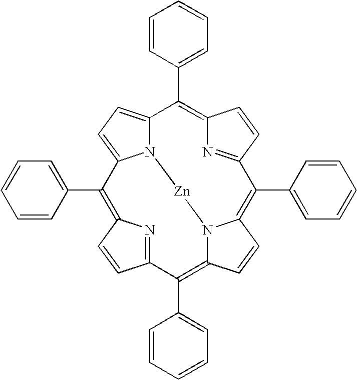

The above-mentioned compounds are dissolved in propylene glycol monomethyl ether (PM) solvent for measurements. The results are shown in Table 1.

TABLE 1

| | | | | Fluorescent | | |
|---|---|---|---|---|---|---|
| | | Max. UV Absorption | | Radiation | | Fluorescent |
| | Compound | Wavelength | | Wavelength | | Efficiency |
| (1) | TPP | 415 | nm | 651 | nm | 0.22 |
| (2) | TPP-OH | 421 | nm | 658 | nm | 0.18 |
| (3) | TPP-COOH | 419.5 | nm | 653.5 | nm | 0.19 |
| (4) | TPP-ADMT | 421 | nm | 659 | nm | 0.24 |
| (5) | Zn-TPP | 423 | nm | 603 | nm | 0.18 |

From the maximal UV absorption wavelength and the fluorescent radiation wavelength of the porphyrin compounds, one can see that the fluorescent multi-layer recording medium using porphyrin is most suitable for data access via a short-wavelength laser (less than 500 nm), particularly the recently developed blue laser (405 nm).

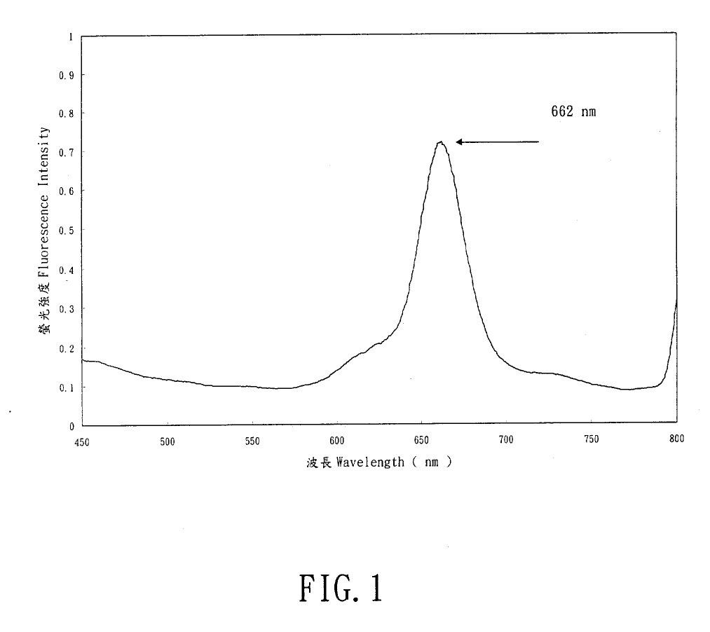

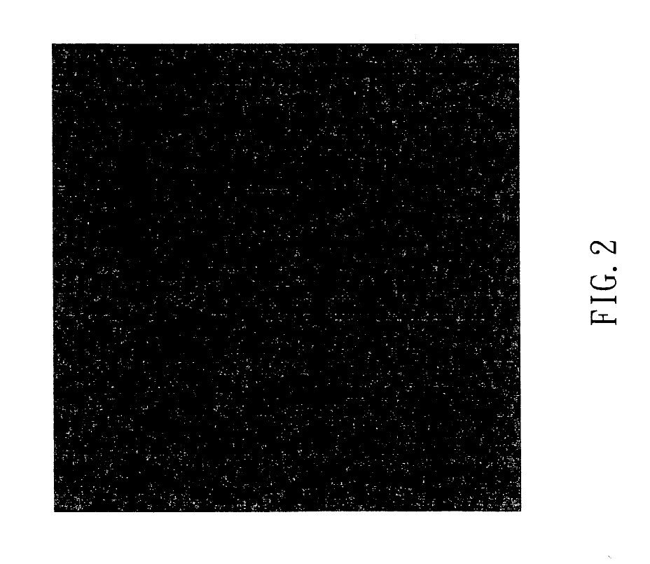

In particular, the compound (2) (i.e. TPP-OH) is made into a fluorescent thin film to measure its properties. TPP-OH is dissolved in a polymer solution, forming a dye solution with a molar concentration 10⁻⁴M. The polymer solution is propylene glycol monoethyl acetate (PGMEA) containing 2% polyvinyl butyral (PVB) in weight (2 wt %). The dye solution is applied on a polycarbonate (PC) transparent substrate and dried, forming a fluorescent recording thin film. The maximal UV absorption wavelength of the thin film is 425 nm (λₘₐₓ=425 nm). When using a blue laser with a wavelength of 405 nm for excitation, the maximal fluorescent radiation wavelength is 662 nm (λₑₘ=662 nm). FIG. 1 shows the fluorescence from TPP-OH formed on the PC substrate. It also shows the red fluorescent radiation excited by the 405 nm blue laser from the thin film. FIG. 2 shows a picture of the red fluorescent signal spots as a 405 nm blue laser beam hits the fluorescent disc.

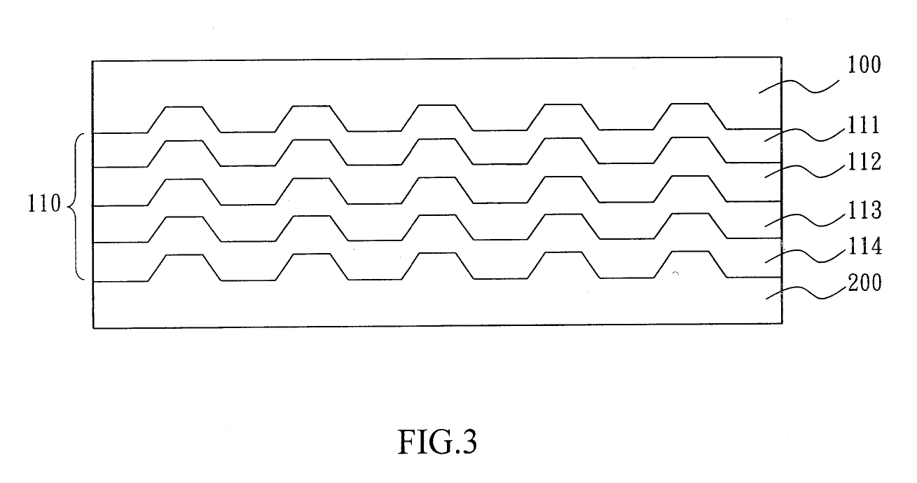

With reference to FIG. 3, the disclosed fluorescent multi-layer recording medium contains: a first substrate 100, a recording stack 110, and a second substrate 200. The first substrate 100 is a transparent substrate (containing tracks or pre-etched signal pits). The recording stack 110 covers the surface of the first substrate 100. It is comprised of a first fluorescent thin film 111, a first separator 112, a second fluorescent thin film 113, and a second separator 114. Both the first fluorescent thin film 111 and the second fluorescent thin film 113 are formed from porphyrin compounds. The second substrate 200 covers the recording stack as the protection layer.

The tracks or pre-etched signal pits on the transparent substrate are used as the signal surface for laser tracking of the pickup head. The recording stack can be made of many layers of fluorescent thin films. The thickness of each fluorescent thin film may range from 50 nm to 1000 nm. A separator is inserted between every two fluorescent thin films.

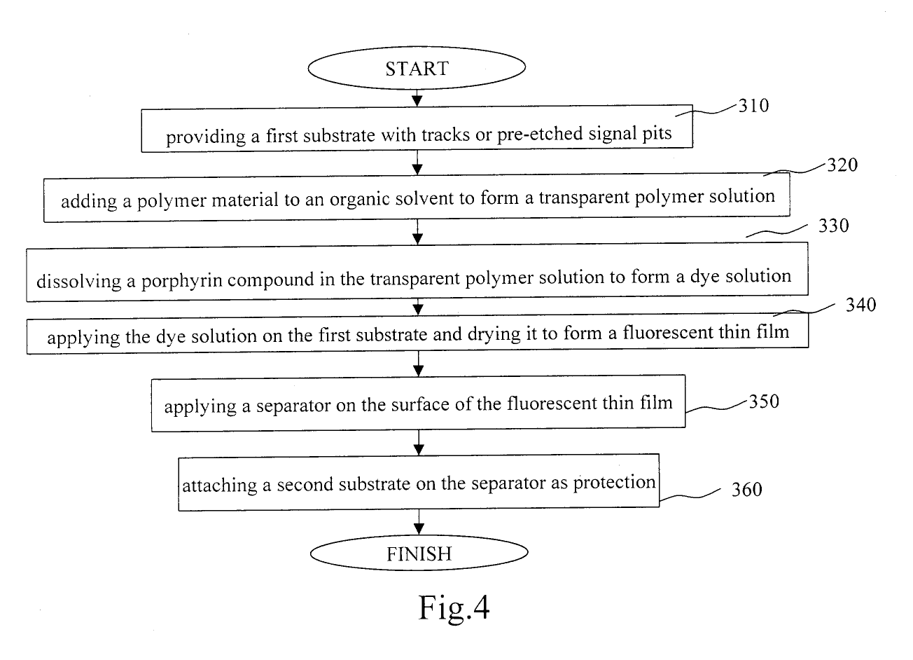

We further disclose a fabrication method for the fluorescent multi-layer recording medium using porphyrin compounds. With reference to FIG. 4, the steps of the method include: providing a first substrate with tracks or pre-etched signal pits (step 310); adding a polymer material to an organic solvent to form a transparent polymer solution (step 320); dissolving a porphyrin compound in the transparent polymer solution to form a dye solution (step 330); applying the dye solution on the first substrate and drying it to form a fluorescent thin film (step 340); applying a separator on the surface of the fluorescent thin film (step 350); attaching a second substrate on the separator as protection (step 360).

The invention further includes the step of repeating steps 340 through 350 for more than once, resulting in multiple layers of fluorescent thin films and separators on the first substrate. The polymer material used here can be selected from chitin, cellulose acetates, or polyethylene (PE) resins. The organic solvent is selected from C₁₋₆ alcohols, C₁₋₆ ketones, C₁₋₆ ethers, dibutyl ethers (DBE), halides, or amides.

Among possible organic solvents, the C₁₋₆ alcohol can be methanol, ethanol, isopropanol, diacetonalchol (DAA), 2,2,3,3-tetrafluoropropanol, trichloroethanol, 2-chloroethanol, octafluoropentanol, or hexafluorobutanol. The C₁₋₆ ketone is selected from acetone, methyl isobutyl ketone (MIBK), methyl ethyl ketone (MEK), propylene glycol monoethyl ether, propylene glycol monoethyl acetate, and 3-hydroxy-3-methyl-2-butanone. The halide can be chloroform, dichloromethane, or 1-chlorobutane. The amide can be dimethylformamide (DMF), dimethylacetamide (DMA), or Methylcyclohexane (MCH). The concentration of the transparent polymer solution is 0.1 to 20 wt %. The preferred range is between 1 and 5 wt %. The concentration of the dye solution of the porphyrin compound in the transparent polymer solution has a molar concentration of 10⁻⁷ to 10⁻²M.

The step of coating the dye solution on the substrate to form a fluorescent thin film uses one method selected from spin coating, roll coating, immersion and inkjet printing. The step of attaching the second substrate on the separator for protection uses one method selected from self-spin coating, halftone printing, thermal gel, and double-sided tapes.

Moreover, the materials of the first substrate and the second substrate can be polyethylene, polycarbonate (PC), polymethylmethacrylate (PMMA), or metallocene catalyzed cyclo olefin copolymer (mCOC). The separator can be a dielectric layer with a thickness between 10 nm and 200 nm or a polymer layer with a thickness between 1 μm and 20 μm. The material of the dielectric layer can be selected from ZnS—SiO2, ZnS, AlN, SiN, or silica aerogel. To enhance the intensity of fluorescent radiation and to elongate the lifetime of the disc, a reflective layer with a thickness between 10 nm and 300 nm can be sputtered between the second substrate and the recording stack. The material of the reflective layer is selected from Au, Ag, Al, Si, Cu, Ag—Ti alloys, Ag—Cr alloys, and Ag—Cu alloys.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A porphyrin compound as the dye in a fluorescent multi-layer recording medium accessed using a short-wavelength laser with a wavelength less than 500 nanometer (nm), which has the following chemical formula: 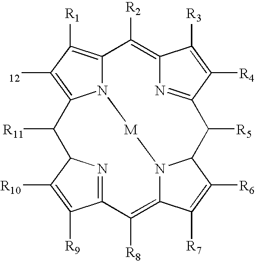
wherein R₁, R₂, R₃, R4, R₅, R₆, R₇, R₈, R₉, R₁₀, R₁₁, and R₁₂ represent the same or different groups, which are selected from hydrogen atoms, halide atoms, C₁₋₈ alkyl groups containing substitute groups, C₁₋₈ alkyl groups not containing substitute groups, C₁₋₈ alkyl-oxygen groups containing substitute groups, C₁₋₈ alkyl-oxygen groups not containing substitute groups, C₁₋₈ alkyl-ethylene groups, nitro heterocycles, carbonyloxy group, nitro groupadamantyl carbonyl groups, adamantyl groups, alkenyl groups, alkynyl groups, amino groups, azo groups, aryl groups, aryloxy groups, arylcarbonyl groups, aryloxycarbonyl groups, arylcarbonyloxy groups, aryloxycarbonyloxy groups, alkylcarbonyl groups, alkylcarbonyloxy groups, alkoxycarbonyloxy groups, alkoxycarbonyl groups, carbamoyl groups, cyanate groups, cyano groups, formyl groups, formyloxy groups, heterocyclic groups, isothiocyanate groups, isocyano groups, isocyanate groups, nitroso groups, perfluoroalkyl groups, perfluoroalkoxy groups, sulfinyl groups, sulfonyl groups, silyl groups, thiocyanate group; and
M is selected from the hydrogen molecule (H₂), Li, Na, Mg, Ca, Sc, Ti, V, Cr, Mo, Mn, Fe, Os, Co, Rh, Ir, Ni, Pd, Pt, Cu, Ag, Au, Zn, Ge, Sn, and Sb.

2. A fluorescent multi-layer recording medium using a porphyrin compound for data access using a short-wavelength laser with a wavelength less than 500 nm, the fluorescent multi-layer recording medium comprising:
a first substrate, which is a transparent substrate with a signal surface;
a recording stack, which covers the signal surface and is comprised of more than one layer of fluorescent thin film, the fluorescent thin film being formed from a porphyrin compound and each two adjacent fluorescent thin films are separated by a separator;
wherein the porphyrin compound has the following chemical formula: 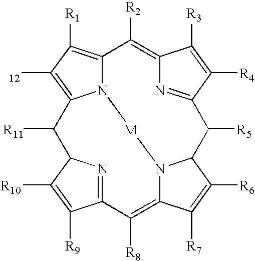
where R₁, R₂, R₃, R4, R₅, R₆, R₇, R₈, R₉, R₁₀, R₁₁, and R₁₂ represent the same or different groups, which are selected from hydrogen atoms, halide atoms, C₁₋₈ alkyl groups containing substitute groups, C₁₋₈ alkyl groups not containing substitute groups, C₁₋₈ alkyl-oxygen groups containing substitute groups, C₁₋₈ alkyl-oxygen groups not containing substitute groups, C₁₋₈ alkyl-ethylene groups, nitro heterocycles, carbonyloxy group, nitro groupadamantyl carbonyl groups, adamantyl groups, alkenyl groups, alkynyl groups, amino groups, azo groups, aryl groups, aryloxy groups, arylcarbonyl groups, aryloxycarbonyl groups, arylcarbonyloxy groups, aryloxycarbonyloxy groups, alkylcarbonyl groups, alkylcarbonyloxy groups, alkoxycarbonyloxy groups, alkoxycarbonyl groups, carbamoyl groups, cyanate groups, cyano groups, formyl groups, formyloxy groups, heterocyclic groups, isothiocyanate groups, isocyano groups, isocyanate groups, nitroso groups, perfluoroalkyl groups, perfluoroalkoxy groups, sulfinyl groups, sulfonyl groups, silyl groups, thiocyanate group;
M is selected from the hydrogen molecule (H₂), Li, Na, Mg, Ca, Sc, Ti, V, Cr, Mo, Mn, Fe, Os, Co, Rh, Ir, Ni, Pd, Pt, Cu, Ag, Au, Zn, Ge, Sn, and Sb; and
a second substrate, which covers the recording stack as a protection layer.

3. The fluorescent multi-layer recording medium using a porphyrin compound of claim 2, wherein the materials of the first substrate and the second substrate are selected from the group consisting of polyethylene, polycarbonate (PC), polymethylmethacrylate (PMMA), and metallocene catalyzed cyclo olefin copolymer (mCOC).

4. The fluorescent multi-layer recording medium using a porphyrin compound of claim 2, wherein the thickness of the fluorescent thin film is between 50 nm and 1000 nm.

5. The fluorescent multi-layer recording medium using a porphyrin compound of claim 2, wherein the separator is selected from a group consisting of a dielectric layer and a polymer layer.

6. The fluorescent multi-layer recording medium using a porphyrin compound of claim 5, wherein the thickness of the dielectric layer is between 10 nm and 200 nm.

7. The fluorescent multi-layer recording medium using a porphyrin compound of claim 5, wherein the material of the dielectric layer is selected from the group consisting of ZnS—SiO2, ZnS, AlN, SiN, and silica aerogel.

8. The fluorescent multi-layer recording medium using a porphyrin compound of claim 5, wherein the thickness of the polymer layer is between 1 μm and 20 μm.

9. The fluorescent multi-layer recording medium using a porphyrin compound of claim 2, wherein a reflective layer is inserted between the second substrate and the recording stack.

10. The fluorescent multi-layer recording medium using a porphyrin compound of claim 2, wherein the thickness of the reflective layer is between 10 nm and 300 nm.

11. A method for making a fluorescent multi-layer recording medium using a porphyrin compound comprising the steps of:
(a) providing a first substrate, which is a transparent substrate with a signal surface;
(b) adding a polymer material to an organic solvent to make a transparent polymer solution;
(c) dissolving a porphyrin compound into the transparent polymer solution to form a dye solution;
(d) applying the dye solution on the first substrate and drying it, forming a fluorescent thin film;
(e) coating a separator on the surface of the fluorescent thin film; and
(f) attaching a second substrate on the separator as a protection layer.

12. The method of claim 11 further comprising the step of repeating steps (d) to (e) after step (e).

13. The method of claim 11, wherein the materials of the first substrate and the second substrate are selected from the group consisting of polyethylene, polycarbonate (PC), polymethylmethacrylate (PMMA), and metallocene catalyzed cyclo olefin copolymer (mCOC).

14. The method of claim 11, wherein the polymer material is selected from the group consisting of chitin, cellulose acetates, and polyethylene resins.

15. The method of claim 11, wherein the concentration of the transparent polymer solution is between 0.1% and 20% in weight.

16. The method of claim 11, wherein the concentration of the transparent polymer solution is preferred to be between 1% and 5% in weight.

17. The method of claim 11, wherein the molar concentration of the dye solution is between 10⁻⁷M and 10⁻²M.

18. The method of claim 11, wherein the fluorescent thin film has a thickness between 50 nm and 1000 nm.

19. The method of claim 11, wherein the separator is selected from the group consisting of a dielectric layer and a polymer layer.

20. The method of claim 19, wherein the dielectric layer has a thickness between 10 nm and 200 nm.

21. The method of claim 19, wherein the material of the dielectric layer is selected from the group consisting of ZnS—SiO2, ZnS, AlN, SiN, and silica aerogel.

22. The method of claim 19, wherein the polymer layer has a thickness between 1 μm and 20 μm.

23. The method of claim 11 further comprising the step of coating a reflective layer on the second substrate before step (f).

24. The method of claim 23, wherein the thickness of the reflective layer is between 10 nm and 300 nm.
